(19) United States
(12) Patent Application Publication
(10) Pub. No.: US 2004/0122715 A1
(43) Pub. Date: Jun. 24, 2004

(54) Health maintenance methodology

(76) Inventor: Thomas P. McAuliffe, Park City, UT (US)

Correspondence Address: Finnegan, Henderson, Farabow,, Garrett & Dunner, L.L.P., 1300 I Street, N.W., Washington, DC, 20005-3315, US

(21) Appl. No.: 10/623,350

(22) Filed: Jul. 18, 2003

Related U.S. Application Data
(60) Provisional application No. 60/396,947, filed on Jul. 18, 2002.
(60) Provisional application No. 60/415,507, filed on Oct. 3, 2002.

(51) Int. Cl. G06F 17/60; G09B 19/18

(52) U.S. Cl. 705/2; 434/107

(57) ABSTRACT

Systems and methods are provided for providing personalized health maintenance advice to a user. According to one illustrative embodiment, a method for determining the degree to which a user complies with a health maintenance program is provided that includes: providing a plurality of prevention elements; weighting the prevention elements relative to one another; determining to what extent the user complies with each prevention element; and determining an overall preventative maintenance score for the user based on the extent to which the user complies with each prevention element.

Applicant claims the right to priority based on Provisional Patent Application No. 60/396,947 filed Jul. 18, 2002 and Provisional Patent Application No. 60/415,507 filed Oct. 3, 2002.

### BACKGROUND

Much of today's healthcare focuses on preventative medicine, as opposed to treatment. Indeed, there is a growing recognition that prevention will likely play a major role in any solution to the current healthcare cost crisis. In addition to cost benefits, the seriousness of many diseases makes prevention, or early detection, the most effective, or only, means of combating the disease. Waiting for symptoms and relying on subsequent treatment can be a costly and often fatal strategy.

For example, with diseases such as lung cancer, ovarian cancer, and stroke, prevention is extremely important, and perhaps the only life-saving strategy. Other diseases, such as colorectal cancer, cervical cancer, melanoma, and heart disease, tend to evolve in distinct stages, and, if detected early, can be effectively stopped with treatment. For these diseases, a combination of prevention and early detection could save millions of lives.

The development of preventative medicine has resulted in the availability of countless research studies, papers, clinical trials, and experiments, which collectively provide definitive prevention measures that can be taken to combat the aforementioned, and many other, diseases. Collating all of the useful and scientifically reliable information, and filtering the unreliable or inaccurate information, however, is a difficult task for patients. Thus, it is difficult for a patient to devise an effective prevention strategy for a disease, and also difficult for the patient to track the extent to which the patient is complying with the prevention measures.

While many institutions in the health care industry offer prevention advice, such advice generally does not, among other things, effectively offer the patient both the assurance of anonymity (in not requiring the patient to disclose personal information), while personalizing the prevention advice according to the patient's lifestyle and predisposition.

### SUMMARY

Systems and methods are provided for providing personalized health maintenance advice to a user. According to one illustrative embodiment, a method for determining the degree to which a user complies with a health maintenance program is provided that includes: providing a plurality of prevention elements; weighting the prevention elements relative to one another; determining to what extent the user complies with each prevention element; and determining an overall preventative maintenance score for the user based on the extent to which the user complies with each prevention element.

According to another illustrative embodiment, a method for providing health maintenance advice is provided that includes: receiving a subscription from a user; sending a health maintenance program to the user without receiving any personal health information from the user, wherein the health maintenance program includes multiple versions; and permitting the user to select from the multiple versions a version that is customized to the user according to the user's personal health information.

According to another illustrative embodiment, a method for providing personalized advice via a website is provided that includes: receiving a subscription from a user via a website; sending an advice program to the user, the advice program including an identifier corresponding to the program sent to the user, and questions and answers calling for personal information from the user, wherein no correlation between the user and the identifier is kept by the website; providing a scoring webpage for the user, wherein the identifier is used to determine the particular advice program sent to the user, and the user is prompted to enter its answers on the website; and generating personalized advice for the user according to the user's answers.

According to another illustrative embodiment, a method for providing personalized advice via a website is provided that includes: receiving a subscription from a user; sending an advice program to the user, the advice program requiring the user to answer certain questions, the answers to which are used to generate personalized advice to the user; providing a webpage for receiving the user's answers, wherein the webpage cannot be effectively utilized without having the advice program; and generating personalized advice for the user according to the user's answers.

According to another illustrative embodiment, a method for providing health maintenance advice is provided that includes sending a plurality of health maintenance programs to a user, each health maintenance program including a plurality of prevention elements; and informing the user as to one or more conflicts between prevention elements from different programs.

### BRIEF DESCRIPTION OF THE DRAWINGS

The accompanying drawings, which are incorporated in and constitute part of this specification, illustrate several embodiments consistent with the invention and together with the description, serve to explain the principles consistent with the invention.

FIG. 1 is a flow chart of a method for providing and utilizing a prevention program in accordance with one illustrative embodiment;

FIG. 2 is a schematic diagram illustrating the manner in which a user subscribes to and scores a prevention program distributed, for example, via the method of FIG. 1;

FIG. 3 illustrates the presentation of a prevention element contained within a prevention program;

FIG. 4 is a scoring sheet and web page used to score a user's compliance with a prevention program;

FIG. 5 is a chart used to display a user's prevention program results;

FIG. 6 is a chart used to display a user's prevention program results for multiple programs;

FIG. 7 is a matrix showing potential conflicts between prevention program elements among multiple prevention programs;

FIG. 8 is a table showing one embodiment of a method for resolving conflicts between prevention programs;

FIG. 9 shows a spreadsheet summary of the scoring results for multiple prevention programs showing prevention element results for each general prevention area;

FIG. 10 shows a spreadsheet summary and corresponding bar graph of the scoring results for multiple prevention programs showing results for each general area; and

FIG. 11 is a functional diagram of an alternative embodiment of a prevention program in which the prevention program includes a toggle capability between laymen and scientific versions.

### DETAILED DESCRIPTION

Reference will now be made in detail to several illustrative embodiments consistent with the present invention, examples of which are shown in the accompanying drawings. Wherever possible, the same reference numbers will be used throughout the drawings to refer to the same or like parts.

A comprehensive health risk reduction methodology is provided in which a user's preventative maintenance is evaluated for a particular disease, multiple diseases, health-related area, or general health, based on the user's compliance with various preventative criteria. The user is informed of the extent to which he or she complies with the preventative criteria, and to what extent the user has taken all preventative measures to reduce the risk of disease. The prevention program (also referred to herein as a health maintenance program) is customized to the particular user without compromising the user's privacy.

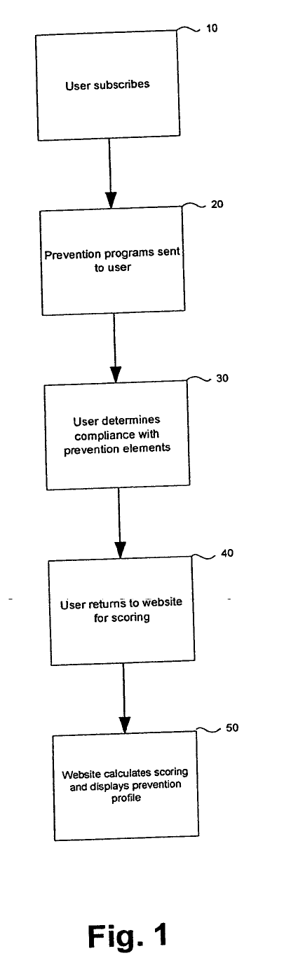

FIGS. 1-6 show one illustrative embodiment consistent with principles of the present invention of a method for providing a user personalized prevention advice and evaluation in which the user's anonymity is assured. The general steps of the method are set forth in FIG. 1.

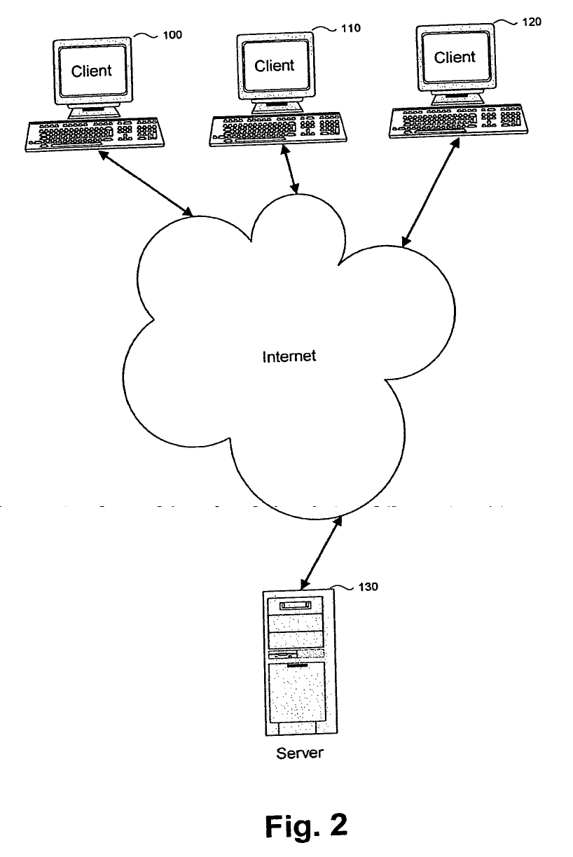

In step 10, the user subscribes to a service that provides prevention advice. Preferably, the subscribing step 10 occurs via the Internet, as shown in FIG. 2. For example, users having Internet access via clients 100, 110, and 120 can access a website offering a subscription to prevention advice operating on server 130. Clients 100, 110, and 120 and server 130 are, for example, general purpose personal computers. When the user subscribes, the user provides certain non-private information, for example, gender, age, and/or zip code. Although in this embodiment subscribing takes place over the Internet, other traditional subscription methods can be used, such as telephone, mail, etc. Payment for the subscription is preferably performed via a secure credit card transaction.

After subscribing, in step 20, the user is sent a prevention program, or library of programs, the versions of which may vary depending on the user's non-private information (e.g., the heart disease program for a male age 50 will be different for a female age 25). Another server, not shown, can be used to send the prevention programs to the user. Examples of diseases that could be the subject of a prevention program include: alzheimer's, breast cancer, cervical cancer, colorectal cancer, depression, diabetes, heart disease, hepatitis C, lung cancer, melanoma, osteoporosis, ovarian cancer, prostate cancer, and stroke, to name a few.

Preferably, the user is sent updates to programs to which the user has subscribed. The programs are updated as medical knowledge evolves, new findings are substantiated, and/or there are material changes in the value of potential preventative actions. All changes from prior versions are preferably highlighted at the beginning of each program so that the user will not have to search for the new information. If the user fully subscribes to the service, the user will be sent new programs as they become available (applicable to the user's age and gender).

In this embodiment, the prevention program (or programs) is sent via email to a user subscribing via client 100. Alternatively, the program can be sent to the user, for example, via Internet download or can be sent to the user on a computer readable medium such as a CD. Although not preferred, the program could also be distributed through the mail in a hard copy paper format.

The prevention program is sent to the user in an electronic format that enables the user to print the program in hard copy format. PDF is an example of an appropriate format for the program, although other document formats, such as TIFF, GIF, MSWORD, etc., can be used. The prevention program includes a program number associated with the user's age group and gender that is submitted to the user with the program. To assure the anonymity of the user, no correlation is kept between the program number and the user to whom the program is sent, however, server 130 keeps a record of the program number and the version of the prevention program to which the program number corresponds, so that the server 130 can accurately score the user's responses when the user returns to the website for scoring (discussed below).

In this embodiment, the prevention program sent to the user generally includes a description of the disease designed to familiarize the reader with the nature and seriousness of each disease, and a series of prevention elements each which describes an area of preventative action that the user can take to avoid the likelihood of contracting the disease, or assist in early detection of the disease. Prevention elements can also be grouped into general areas such as:

Diagnostic Testing/Screening

Preventative Medications/Procedures

Nutrition

Physical Activity

Substance Use

Mental Health

Environmental/Occupational Exposures

Complementary and Alternative Methods

Related Conditions

Genetics

Family History

Demographics

Each general area can include one or more prevention elements. Each prevention element is in turn “weighted” (e.g., from 1 to 10) according to its importance, to inform the user as to which actions are more important in reducing the risk of disease (and therefore weighted higher), and to calculate an overall preventative maintenance score for the user (discussed below). Each prevention element includes quantitative benchmarks which, along with the weighting of the prevention element, are determined based on the most current and reliable medical evidence. The user chooses the benchmark that best represents the user's level of compliance with the prevention element.

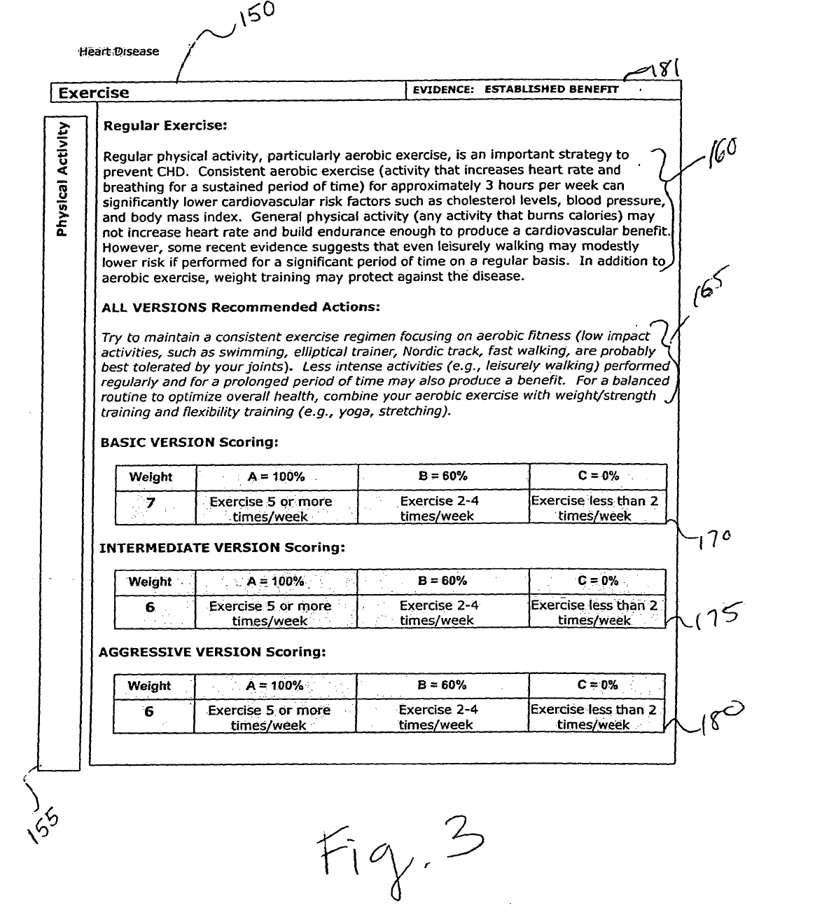

By way of example, FIG. 3 shows a single prevention element as it appears on a page of a prevention program for heart disease. In this example, the prevention element 150 is “Exercise” under the general area 155 of “Physical Activity.” Preferably, the general areas 155 will be common to most prevention programs in the library. The prevention element page of FIG. 3 also includes a general description 160 of the prevention element and a generalized recommended action summary 165 corresponding to the benchmark.

This prevention element example includes three different benchmark versions: basic 170, intermediate 175, and aggressive 180, designed to address different levels of pre-disposition or initial risk levels. In the foregoing illustrative embodiment, the user selects the particular version to use based on a series of risk factors set forth at the beginning of the prevention program. The risk factors are typically based on lifestyle habits, family history, and/or physical or mental states. Some risk factors suggest the use of the aggressive version while other suggest the use of the intermediate version.

Certain, or all, benchmarks can be different in the basic, intermediate and aggressive program versions. Generally, if the user shows a greater pre-disposition for the disease, it is preferable to provide more aggressive preventative benchmarks and/or additional preventative benchmarks. For example, aggressive version (for users indicating the highest pre-disposition) may include a prevention benchmark that requires the user to have a particular examination at a younger age than required in intermediate version, and version may require that examination be a younger age than required in basic version. Also, the aggressive version may include additional preventative benchmarks not found in version, and so forth, e.g., there may be an additional screening test in aggressive version not included in the intermediate or basic versions, etc.

For example, if the user has a family member diagnosed with heart disease before the age of 55, the prevention program would recommend use of the aggressive version benchmarks. In the absence of any risk factors the user selects the basic version. To protect privacy, each program contains the recommended actions for all three versions. Thus, it is up to the user to determine the most appropriate version for his or herself, and the user need not reveal (when subscribing) whether the user possesses any of the risk factors. This privacy aspect encourages the user to be frank when deciding which version is appropriate.

In the example shown in FIG. 3, the benchmarks for all three versions are the same, although the basic version is weighted slightly higher, indicating that exercise is slightly more important in this version as compared to the intermediate and aggressive versions. The user selects benchmark A, B, or C depending on the extent of the user's compliance with the prevention element, in this case, the amount of times the user exercises per week.

Also shown in the prevention element page shown in FIG. 3 is an evidence rating 181 corresponding to the prevention element. The evidence rating informs the user regarding the relative strength of scientific evidence to support the relevance and efficacy of the action (or inaction) suggested by the prevention element. For example, one possible range of evidence ratings includes:

1. Established benefit. Evidence based on one or more well-designed randomized clinical trials with adequate sample size, or solid evidence from multiple well-designed epidemiological studies all pointing in the same direction (preferably summarized in one or more meta-analyses). In order to be considered an established benefit, no credible evidence to the contrary should exist.

2. Probable Benefit. Evidence based on some well-designed epidemiological studies, with some supporting theoretical rationale. In order to be considered a probable benefit, little credible evidence to the contrary should exist.

3. Speculative Benefit. Evidence based on some combination of observational studies, case reports, animal studies, laboratory research, and a theoretical rationale. Not all evidence for a speculative strategy points to a clear or probable preventative benefit (e.g., in many instances, approximately half of the evidence suggests a benefit, while the other half suggests no benefit).

4. No Benefit. Evidence based on at least one well-designed epidemiological or clinical study; the preponderance of the evidence suggests that the proposed prevention strategy does not protect against the specific disease.

5. Insufficient Data. Evidence is too limited to be allotted any of the above ratings. Strategies labeled “insufficient data” are often newer and have not been examined adequately.

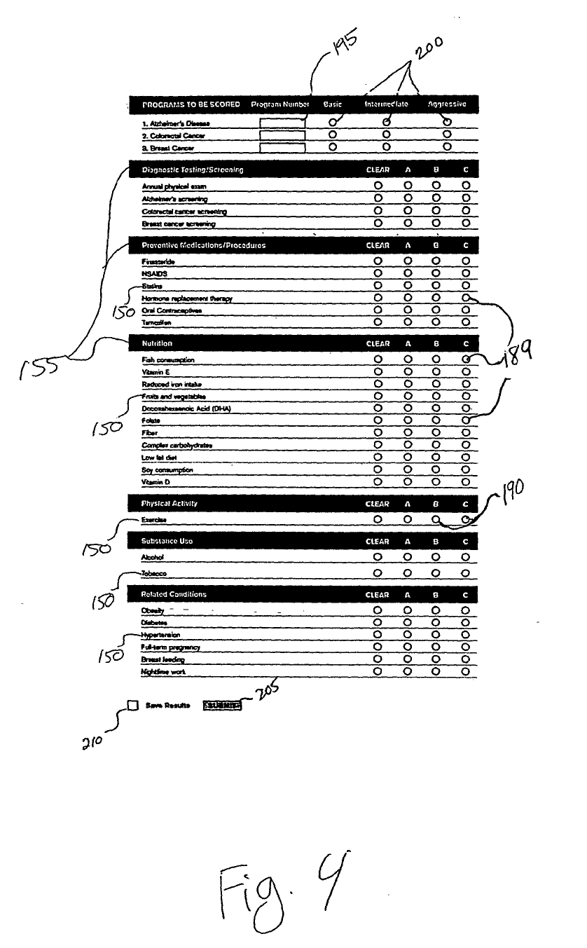

Thus, the user proceeds through the prevention program to determine the extent to which he or she complies with each prevention element by selecting an appropriate benchmark for each prevention element (FIG. 1, step 30). A scoring sheet, either downloaded from the server 130 by the user, or emailed with the prevention program, assists the user in recording the user's answers to each prevention element. An example of a scoring sheet is shown in FIG. 4. The scoring sheet can be printed out by the user, and the appropriate benchmark 189 physically marked by the user for each prevention element. For example, using the prevention element shown in FIG. 3, if the user exercised 24 time per week (using any of the three versions), the user would mark circle 190 of the scoring sheet shown in FIG. 4.

After completing the prevention program by selecting an appropriate benchmark for each prevention element and filing out the scoring sheet accordingly, the user is ready to determine his or her total preventative maintenance score for the prevention program in question. In accordance with the foregoing illustrative embodiment, in step 40, the user-does this by returning to the prevention website operating on server 130 (at which the user subscribed to the prevention service).

The user is directed to a web page, preferably appearing substantially the same as the scoring sheet shown in FIG. 4. In space 195, via client 100, the user interacts with the scoring web page by entering the program number corresponding to the users' prevention program, that is, for example, printed on the front page of the prevention program sent to the user in step 20. The user also, using a mouse to click on the appropriate circle 200, selects the version the user used in the prevention program. With these two pieces of information, the website software program operating on server 130 will be able to identify both the specific prevention program the user completed, and the answers corresponding to each circle that the user clicks.

In the foregoing illustrative embodiment, generally, the website operating on server 130 permits free access for all users, whether a visitor or a subscriber. No passwords or user IDs are necessary to enter the website or to access the scoring web page (FIG. 4). All interactions are anonymous and the server 130 does not record visits or store cookies, thus protecting the privacy of subscribers and visitors alike. Without having subscribed and received the prevention program and program number, however, a visitor has no way of knowing what benchmark answers correspond to the circles on the scoring sheet and thus cannot effectively use the scoring page. The website preferably includes a visitor's path to enable a visitor to use a sample program to familiarize the visitor with the manner in which the prevention program operates. The website also includes a subscriber's path, however, no password is necessary to enter the subscriber's path. Thus, any user, whether visitor or subscriber, can enter the subscriber path.

When the user checks a circle for each prevention element and clicks the “submit” box 205, the website program operating on server 130 performs a simple mathematical calculation to determine the user's preventative maintenance “score.” The calculation adds up all of the weight values (FIG. 3) achieved for each prevention element, and determines how many, and what percentage of the total available prevention points the user achieved. It should be noted that a user could perform the scoring calculation himself without much effort, thus making it unnecessary to return to the website for scoring. For example, for the prevention element of FIG. 3, if a user's benchmark for the basic version was “B”, the user achieved 60% of 7 prevention points, i.e., 4.2 points.

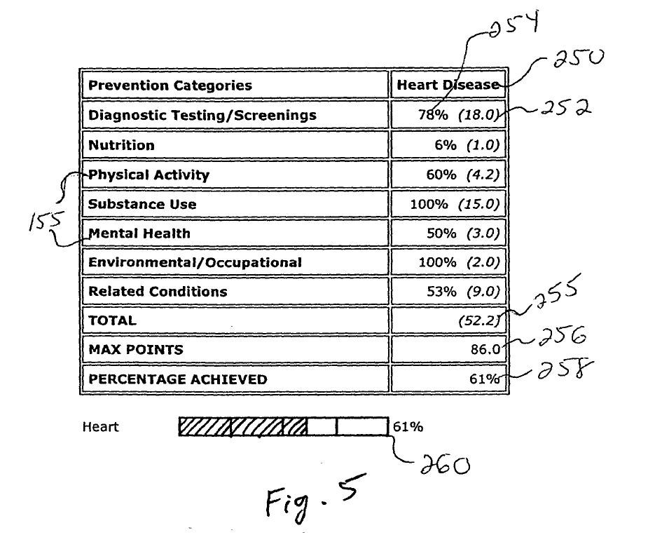

The website program then (FIG. 1, step 50) displays the scoring results for the user, for example, in the format shown in FIG. 5. In the chart of FIG. 5, the user's results for the particular prevention program 250 are displayed in terms of compliance within each general prevention area 155. Alternatively, an expanded chart could also show the compliance with each benchmark with each general area. The chart shows the total points 252 achieved for each area, the percentage 254 of total points achieved for each area, the total points accumulated in all areas 255, the maximum points that could be achieved 256, and the percentage of total points achieved 258 (also shown in the form of a bar graph 260).

Thus, in the example of FIG. 5, the user achieved 52.2 out of a possible 86 prevention points, meaning the user in this case has achieved 61% of the prevention points available. A perfect score of 100% indicates that the user is performing every possible preventative measure indicated in the prevention program. It should be noted that this number gives no prediction as to the likelihood of a particular user actually acquiring the disease, it rather indicates that the user is performing all prevention measures in the program.

The scoring web page shown in FIG. 4 also gives the user the option of saving the scoring results by checking the “save results” box 210. If the user checks this box, a random number is generated, displayed to the user, and the user is instructed to save the number. On subsequent visits, the user is given the option of entering the random number and recalling these results. The user can then update or make changes without re-entering all the benchmark answers. Since the random number is not correlated to the user, privacy is again assured.

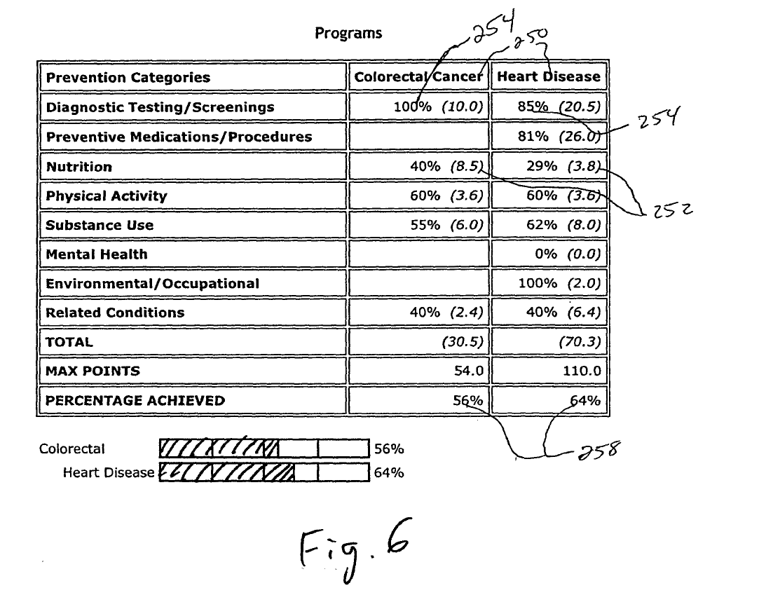

As indicated in FIG. 4, if the user subscribed to multiple prevention programs the user can simultaneously score the programs together by entering multiple programs numbers (195) and versions (200). If so, the chart of FIG. 5 would be expanded to includes more columns for the additional diseases. FIG. 6 shows the resultant chart from a user scoring colorectal cancer and heart disease prevention programs. It should be noted that some prevention elements and general areas are not relevant to prevention of certain diseases. For example, in this example, the general areas of preventative medications/procedures, mental health, and environmental/occupational do not have prevention elements applicable to colorectal cancer and therefore no compliance value is entered in those rows.

The scoring sheet of FIG. 4 can be used to score multiple prevention programs. Preferably, there will be a notation on the scoring sheet next to each prevention element showing the user which program the prevention element applies to (since, as stated above, some prevention elements are not applicable to some prevention programs). Additionally, many programs use the same prevention elements. For example, exercise is proven to be an efficacious prevention element for many diseases. Preferably, the benchmarks for a prevention element are the same for each program being scored, thus, a single answer (A, B, or C) is used to calculate scores for each program in which the prevention element applies. (Although it should be noted that the “weight” assigned to the prevention element can still vary across multiple programs.) Alternatively, if the benchmarks are different, two (or more) entries can occur for the same prevention element corresponding to each prevention program.

Because some prevention elements are not applicable to certain prevention programs, there is the possibility that the user clicks the answer to an inapplicable prevention element, or misses filling in a benchmark for a prevention element. Preferably, the website software program automatically generate a list of missing items, and generate a scoring chart (FIGS. 5 and 6). The scoring will not be affected by the missing element, but the user will be informed and permitted to return to the scoring page to fill in the missing element. The website program will ignore prevention elements that are answered that are not applicable to the program in question.

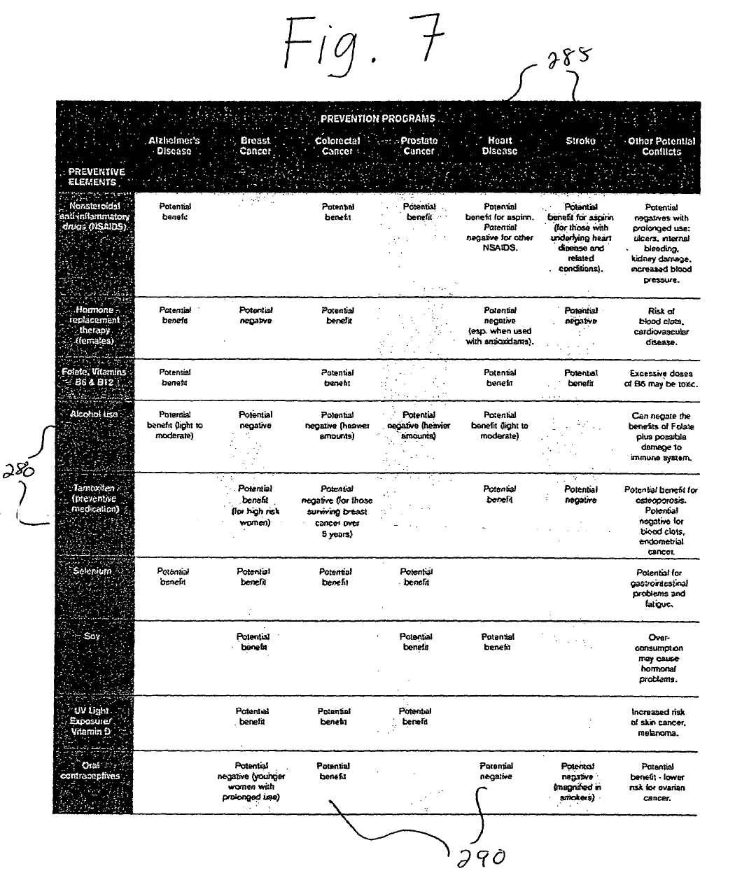

According to an alternative illustrative embodiment, the user is alerted to potential conflicts between preventative actions recommended by different programs. It is sometimes the case that an action taken to reduce risk for one or several diseases might actually increase risk for others or create harmful side affects. Accordingly, the user is made aware of these conflicts, and informed which conflicting element may be the best to follow. The user is informed of conflicts via a separate email (or in the same email), which includes a potential conflict matrix attached thereto. A conflict matrix is shown in FIG. 7, in which the prevention elements 280 fill the left column, and prevention programs fill the top row. Scanning across the row of a prevention element reveals whether the prevention element is a potential benefit or negative, and may include details of the benefit or negative.

In another alternative illustrative embodiment, the user is provided a recommendation as to whether following the conflicting element is more of a benefit or a detriment. The conflict is summarized and the user is advised on how to balance or reconcile the conflict, preferably in another document sent with, or separate from, the prevention programs. Since the conflicts will be apparent in the particular program library sent to the user, preferably the prevention programs will automatically advise the user, based on current medical research, on how to resolve the conflict, e.g., by lowering conformance with one element in favor of a more serious, conflicting element. The user, however, will be advised to consult with his or her own physician for review of the suggested preventative maintenance and personal modification.

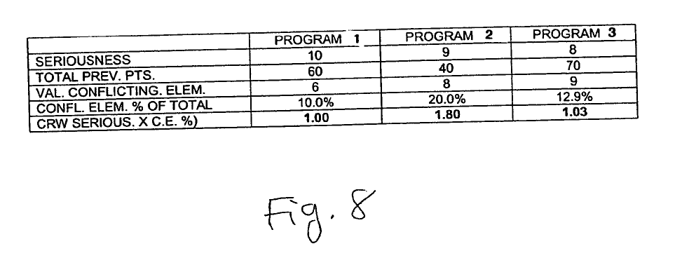

In another alternative illustrative embodiment, the website program will automatically recognize a conflicting element in the total package of programs sent to the user and resolve the conflict by prioritizing the elements, and send the results to the user. An example of this is shown in the chart of FIG. 8. Each prevention program (1, 2, and 3) includes a seriousness rating associated therewith. The prevention value for the conflicting element is measured as a percentage of a total prevention value within each program (“CONFL. ELEM. % OF TOTAL”). This gives an indication of the importance of the preventative element within the particular disease program. For example, in Program 1 the total prevention program points is 60 and the value of the conflicting element is 6, thus, the element percentage of the total preventative points is 10%. The seriousness rating of each disease program is multiplied times this conflicting element percentage to generate a weighting number, called a conflict resolution weighting (CRW). The highest CRW indicates that the prevention element for that prevention program should be followed.

In the example of FIG. 8, it is suggested that the actions recommended in Program 2 with a CRW of 1.8 should take precedence over the conflicting elements presented in Programs 1 and 3, having CRWs of 1.0 and 1.03, respectively. It is recommended, however, that a personal physician should be the final judge of the values presented by the prevention programs, the suggested resolution of any potential conflicts, and the recommended prevention actions.

In accordance with another alternative embodiment, a self-contained program is sent to the user in which there is no need for the user to return to the website for scoring (as in step 40 of FIG. 1). The prevention program sent to the user itself performs the scoring calculation referred to in step 50 of FIG. 1. Microsoft Excel is an example of a program that is appropriate for implementing a prevention program in this embodiment, however, as would be apparent to one having ordinary skill in the art, the invention is not limited to any particular programming language or platform and various different languages, programs or platforms can be used consistent with principles of the present invention.

Appendix A shows an example of the self-contained program of the foregoing alternative embodiment, implemented in Excel. Similar to the previous embodiment, the program includes a condition description as well as a condition seriousness rating from 1 to 10 with 10 being the most serious. The condition seriousness rating is used to evaluate the seriousness of a particular disease.

As in the embodiment of FIGS. 1-6, the seriousness rating can be determined by a review of population and mortality statistics to determine the risk of the disease for the age, gender and location of the user. Also, research and literature can be consulted to determine the seriousness (likely outcome) of the disease and the extent to which the disease is preventable. For example, females may be less susceptible to a particular disease than males, in which case the condition seriousness number would be lower in the disease program sent to the female. The condition seriousness rating informs the user as to the relative seriousness of multiple diseases, and, as described above with reference to FIGS. 7 and 8, can also be used by the user or the prevention program to evaluate the importance of following a particular prevention element in one disease versus a particular element in a less serious disease.

For example, in the illustrative example of Appendix A, the prevention element cholesterol has a prevention value of 10 (analogous to the “weight” of FIG. 3) and is considered by the program to be slightly more important for the user to comply with to reduce risk of the disease than prevention element “body fat” which has a prevention value of 9.

To execute the program, the user is prompted, for each prevention program element (under the shaded column “ENTER”), to enter the user's achievement according to weighted benchmarks. Preferably, the user's selection and entering of benchmarks is self-administered to assure the user of privacy which will potentially result in more honest answers. For example, in the body fat prevention element of the heart disease program, the user has entered 70% indicating the user's body fat percentage is in the range 15-19. A value of under 10 or less would yield a 100% benchmark indicating that the user fully complies with the prevention element and yields the full 9 points score for body fat. Since the user falls into the 70% compliant benchmark, the user receives 70% of the available points, i.e., 6.3, which is automatically calculated by the Excel program and instantaneously appears in the “POINTS” column.

In the exercise prevention program element, the user has indicated that he or she exercises 45-59 minutes per day, yielding a 70% benchmark value and point total of 6.0. Negative scoring is also possible for harmful lifestyle patterns. (See, for example, the alcohol prevention element associated with the program. A consumption of excessive alcohol results in points being taken away indicated by “(200%)”.)

The prevention program elements may also contain sub-elements. For example, cholesterol includes sub-elements LDL, HDL and triglycerides which are allocated 3.5, 3.5 and 3.0 points out of the 10 total prevention element points for cholesterol, respectively. Like the prevention element points, the sub-element points are also allocated according to prevention importance. For example, in the illustrative embodiment, LDL and HDL are considered slightly more important than triglycerides, and have a higher point value (3.5 versus 3.0).

Accordingly, the user goes through each program element entering the appropriate benchmark. Once the user has registered his or her benchmark score for each prevention element, at the end of the prevention program, the program automatically adds the points together and generates a total weighted score. In the illustrative embodiment of the heart disease prevention program shown in Appendix A, the user achieved 31.8 of a possible of 68.5 points (the more points indicate a better preventative maintenance score) resulting in a total weighted score of 46.4%, meaning the user in this case has achieved 46.4% of the prevention benchmarks available.

A perfect score of 100% indicates that the user is performing every possible preventive measure set forth in the prevention program. In this embodiment, if the program was distributed in paper format, the user, or someone else, could simply fill the scores in by hand, and use a calculator to manually determine the overall score. It should again be noted that this number gives no prediction as to the likelihood of a particular user actually acquiring the disease, it rather just indicates that that particular user is performing every possible preventative maintenance.

In the Appendix A program, the user is also informed of various other factors that may affect risk in addition to the measurable benchmarks (“Other factors that may affect your risk”). These factors are not scored in the manner discussed above, but are presented as supplements to the weighted average score, and can be given quantitative (affecting the score) or qualitative values. In this way the user is further educated as to his or her specific risks as regards the specific disease in question. The user is also encouraged to discuss the results with a physician.

In all embodiments herein, the numerical values used in the prevention element weighting and user benchmarks preferably are periodically updated and sent to the user as medical and scientific knowledge evolve. Any changes can be highlighted from previous editions of the program. In a subscriber based system, the new programs can be automatically submitted to the subscriber based on the subscriber's initial information input (e.g., gender and age).

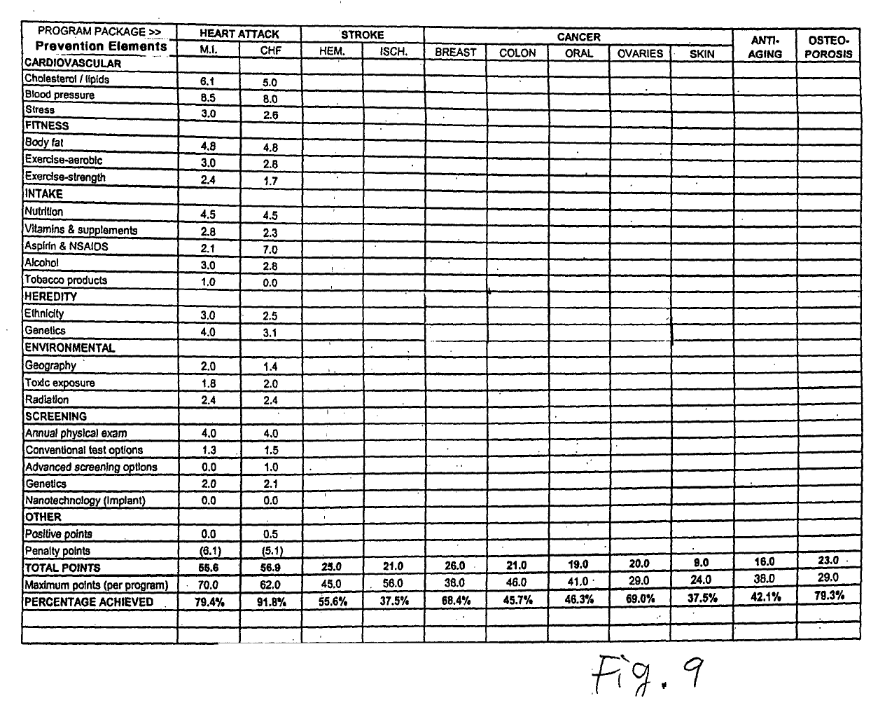

FIG. 9 shows an additional manner in which the results of a prevention program library can be combined in spreadsheet form to provide a comprehensive all in one display for the user. Shown in FIG. 9 are two heart attack disease programs, two stroke disease programs, several cancer disease programs, an anti-aging program and an osteoporosis program. Heart attack programs are myocardial infraction and congestive heart failure. Each prevention element is grouped into its general area, for example, cardiovascular fitness, intake, etc.

As shown in FIG. 9, the prevention programs described herein need not be directed to a disease but could be directed to other health areas such as the immune system or aging in general. In such a case the prevention elements would be relevant to having a strong immune system or slowing aging. The results of any of the prevention programs can also be used for early detection of disease where the user has indicated poor preventative maintenance.

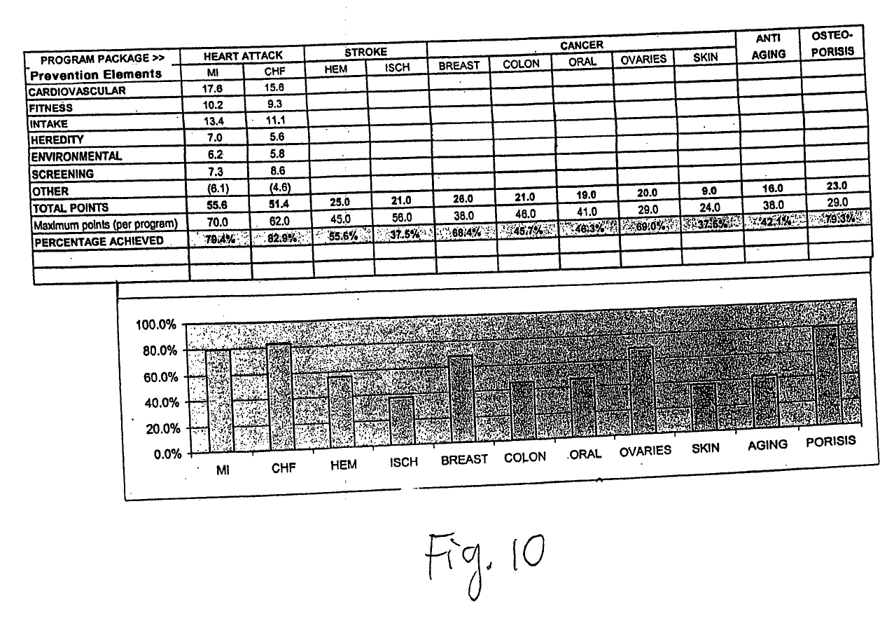

FIG. 10 shows a further summary in which only the total points in each general prevention area (but not the individual prevention elements) are shown as well as a bar graph illustrating the total percentage of prevention maintenance for each prevention program. In this way the user can easily determine the prevention program in which the user has the most room to improve, in terms of preventative maintenance.

According to another illustrative embodiment, the user is sent a range of program versions from basic to aggressive for each disease in question. Based on the user's personal risk assessment, a particular program version is chosen for each disease. For example, the program may ask the user whether he or she has a family history of the particular disease. Based on the answer to this question, the benchmarks, program elements and condition seriousness could be selected internally by the program, as opposed to the embodiment of FIG. 3, in which all three versions (basic, intermediate, and aggressive) are displayed, and the user self-reviews the risk factors and elects to use one of the versions.

Thus, in this alternative illustrative embodiment, different program versions may be made available according to the user's answers to the personalized risk assessments. By way of example, if the user indicates a family history, the prevention element related to testing may require more detailed testing to receive a score of 100%. Another example of a personalized risk assessment would be if the user indicates they have a heart arrhythmia which would alter the program version or program values used in the heart attack disease prevention program.

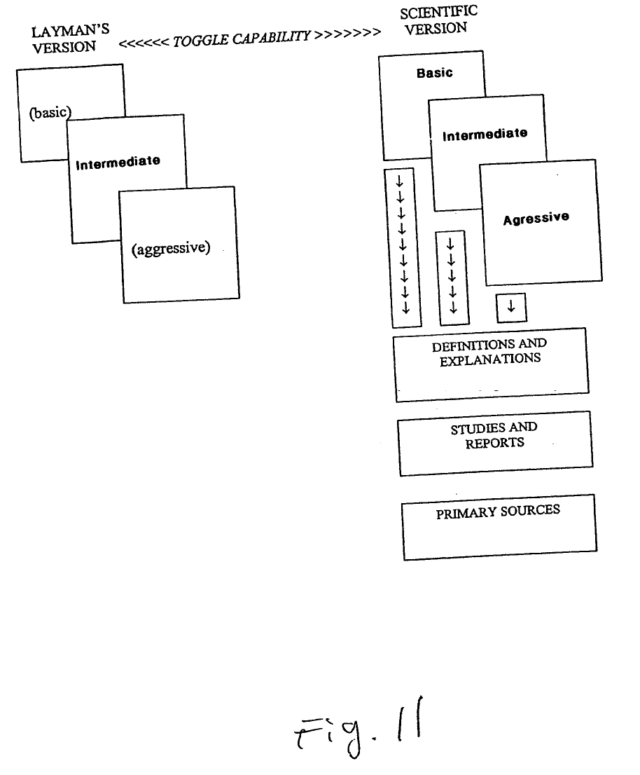

According to another alternative illustrative embodiment, as illustrated in FIG. 11, the program can include a “toggle” capability between a layman's version and an expert version for use by, for example, physicians. The toggle permits a user to switch back and forth (for example, by clicking on an icon) between two program versions, one in technical medical language and another in layman's terms, for a user not learned in medical terminology. Additionally, the scientific version of the program could be layered, in which particular terms or prevention elements in the program could have “technical details” associated therewith which include: definitions and explanations, studies and reports, and primary sources of technical information which are not of interest to the average subscriber. In this “layered” alternative, clicking on a particular element causes the technical details associated with that element to be displayed, similar to the manner in which a hypertext link in a website reveals further information about the highlighted term or phrase.

As shown in FIG. 11, the program (either the layman version or the scientific version) can also include more or less aggressive disease program versions based on the user's response to initial questions in the program relating to whether the user has a pre-disposition for the particular disease, for example, questions regarding the user's family history and/or the existence of any contributing factors such as the presence basic symptoms, obesity, etc. Thus, the user would be prompted to program version (basic, intermediate, or aggressive) based on the user's answers to the initial questions. For example, the “basic” version would be used if the user indicates no pre-disposition because of a lack of family history and lack of contributing factors. The “intermediate” version would be used if the user indicates a moderate pre-disposition based on some degree of a family history and/or the presence of some number of contributing factors. Lastly, the “aggressive” version would be used if the user indicates a high pre-disposition by having a serious family history and/or the presence of strong contributing factors.

Preferably, as in previous embodiments, whether the program is in paper format or in electronic form, all three versions of the program, basic, intermediate, and aggressive, would be received by the user, thus making it unnecessary for the user to answer questions regarding family history and basic symptoms when subscribing to the service.

In accordance with another alternative illustrative embodiment, a challenge response format can be used in which the user answers questions displayed on the website on server 130. For example, the user is prompted to answer general health factor questions as well as disease specific factor questions. The general health factor questions tend to be questions related to factors (e.g., exercise) that impact several, if not all, categories of risk across several prevention programs, avoiding the need for the user to have to answer the same benchmark question several times. After answering these general health factor questions, the subscriber will be prompted to answer prevention program-specific questions.

The subscriber is automatically prompted to answer prevention program specific questions corresponding to several of the more serious major diseases, such as cancer or heart-related diseases, so that after answering such questions a graphic profile matrix of the serious major diseases is automatically generated (see e.g., FIG. 10). The subscriber may then be given the option of choosing additional programs not offered in the standard library for his or her age and gender group, or a general health program. Alternatively, the user can simply select specific prevention programs after answering the general health factor questions, although this is less preferred as the user might end up ignoring a disease that presents a serious risk for that user.

In this alternative embodiment, the subscriber documents include questions and answers while the web site only shows the questions and prompts the user to select a character (for example, A, B, C or D) that is matched with the answer in the subscriber documents. This is slightly different from the embodiment of FIGS. 1-6 in which only the title of the prevention element is shown (FIG. 4) on the web page. Similar to the previous embodiment, a visitor entering the subscriber path will not have access to the answers and would not be able to effectively use the disease program. Appendix B shows a simplified example of a page of a prevention program as would be displayed to a user executing the program over the Internet in accordance with this embodiment.

As discussed above, the benchmarks (indicated by XXXXs) are not visible to one viewing the web page and thus the subscriber would have to refer to their subscriber documents to determine what benchmark, A, B, C, D, etc., corresponds to. The user would then click on the appropriate benchmark. Thus, the subscriber documents and the disease program displayed on the website can be substantially similar with the exception that on the website the benchmark answers are only indicated by a letter corresponding to the subscriber document answer.

As in previous embodiments, the website will use the user's answers to the general health factors and disease specific factor questions and generate a total value of prevention element achievement as in previous embodiments.

Although the foregoing embodiments refers to disease prevention programs, the principles discussed above can be applied to any type of web-based application in which subscriber information is separately sent to the user and the user is able to anonymously use the subscriber information to effectively use a web-based program. For example, a stock portfolio analysis program can be provided in which the subscriber documents include specific questions and answers about their portfolio; the user can anonymously enter the website to select characters corresponding to said answers and the analysis program operating on the web server will evaluate the portfolio and present an anonymous recommendation.

It will be apparent to those skilled in the art that additional various modifications and variations can be made in the present invention without departing from the scope or spirit of the invention. Other embodiments of the invention will be apparent to those skilled in the art from consideration of the specification and practice disclosed herein. It is intended that the specification, examples and exemplary claims be considered as exemplary only, with a true scope and spirit of the invention being indicated by any claims issuing therefrom.

1. A method for determining the degree to which a user complies with a health maintenance program, comprising:
(A) providing a plurality of prevention elements;
(B) weighting the prevention elements relative to one another;
(D) determining to what extent the user complies with each prevention element; and
(D) determining an overall preventative maintenance score for the user based on the extent to which the user complies with each prevention element.

2. The method of claim 1, wherein more heavily weighted prevention elements impact the overall preventative maintenance score more than less heavily weighted prevention elements.

3. The method of claim 1, wherein the health maintenance program is directed to the prevention of a particular disease.

4. A method for providing health maintenance advice, comprising:
(A) receiving a subscription from a user;
(B) sending a health maintenance program to the user without receiving any personal health information from the user, wherein the health maintenance program includes multiple versions; and
(C) permitting the user to select from the multiple versions a version that is customized to the user according to the user's personal health information.

5. The method of claim 4, further comprising receiving certain non-private information from the user, and step (B) includes sending the user a particular health maintenance program based on said non-private information.

6. The method of claim 5, wherein the non-private information includes at least one of age and gender.

7. The method of claim 4, wherein the user's personal health information includes at least one of lifestyle habits, family history, physical state, mental state, and symptoms.

8. The method of claim 4, wherein the multiple versions include a basic, intermediate, and aggressive version.

9. A method for providing personalized advice via a website, comprising:
(A) receiving a subscription from a user via a website;
(B) sending an advice program to the user, the advice program including an identifier corresponding to the program sent to the user, and questions and answers calling for personal information from the user, wherein no correlation between the user and the identifier is kept by the website;
(C) providing a scoring webpage for the user, wherein the identifier is used to determine the particular advice program sent to the user, and the user is prompted to enter its answers on the website; and
(D) generating personalized advice for the user according to the user's answers.

10. The method of claim 9, wherein step (C) includes the use of an answer key in which the text of the answers is not shown.

11. A method for providing personalized advice via a website, comprising:
(A) receiving a subscription from a user;
(B) sending an advice program to the user, the advice program requiring the user to answer certain questions, the answers to which are used to generate personalized advice to the user;
(C) providing a webpage for receiving the user's answers, wherein the webpage cannot be effectively utilized without having the advice program; and
(D) generating personalized advice for the user according to the user's answers.

12. A method for providing health maintenance advice, comprising:
(A) sending a plurality of health maintenance programs to a user, each health maintenance program including a plurality of prevention elements; and
(B) informing the user as to one or more conflicts between prevention elements from different programs.

13. The method of claim 12, wherein one or more conflicts include a prevention element that is a potential benefit for one health maintenance program while a negative for another health maintenance program.
